(19) United States
(12) Patent Application Publication
(10) Pub. No.: US 2026/0170529 A1
(43) Pub. Date: Jun. 18, 2026

(54) SYSTEMS AND METHODS OF FACILITATING USER-SUBSIDIZED PURCHASE OF A PRODUCT OR A SERVICE BASED ON ACTIVE ADVERTISEMENT VIEWING

(71) Applicants: Luc Nguyen, Houston, TX (US); Peter DeNagy, Frisco, TX (US); Donald Workman, Mahtomedi, MN (US); Frank Befera, Apopka, FL (US)

(72) Inventors: Luc Nguyen, Houston, TX (US); Peter DeNagy, Frisco, TX (US); Donald Workman, Mahtomedi, MN (US); Frank Befera, Apopka, FL (US)

(21) Appl. No.: 19/373,371

(22) Filed: Oct. 29, 2025

Related U.S. Application Data
(60) Provisional application No. 63/713,430, filed on Oct. 29, 2024.

(51) Int. Cl. G06Q 30/0226; G06Q 30/0241; G06Q 30/0242

(52) U.S. Cl. CPC G06Q 30/0231; G06Q 30/0242; G06Q 30/0277

(57) ABSTRACT

The present disclosure provides a method of facilitating user-subsidized purchase of a product or a service based on active advertisement viewing. Further, the method may include receiving an advertisement selection data from a client device. Further, the method may include receiving an advertisement interaction data representing a user interaction with a selected advertisement from the client device. Further, the method may include determining a point value associated with the advertisement interaction data. Further, the method may include accumulating a total point data based on the point value. Further, the method may include storing the total point data in association with a user account data. Further, the method may include transmitting a credit data representing a redeemable value derived from the total point data to the client device.

### FIELD OF DISCLOSURE

The present disclosure generally relates to electric communication technique. More specifically, the present disclosure relates to systems and methods of facilitating user-subsidized purchase of a product or a service based on active advertisement viewing.

### BACKGROUND

The present disclosure relates generally to the field of digital advertising and network-based data analytics. This field is of growing importance in modern digital ecosystems where service providers, advertisers, and users interact through interconnected communication networks. With the proliferation of connected devices and high-speed network infrastructures, digital advertising has become a primary channel through which businesses reach potential consumers. Efficient utilization of network data and artificial intelligence techniques has become increasingly critical to improving personalization, relevance, and efficiency of advertisement delivery.

An objective that is desirable to be achieved in this field is to enable a system or platform capable of delivering personalized and contextually relevant advertisements to users in a way that optimizes both user engagement and network resource utilization. Such a system should be capable of leveraging network-level information to understand user behavior, infer interests, and intelligently manage advertisement distribution. Furthermore, advertisers and sponsors seek greater insight into how advertisements perform, why certain content resonates with users, and how delivery strategies can be adapted in real time.

Existing systems and methods for digital advertisement delivery face several challenges in achieving these objectives. Conventional advertising platforms typically rely on user-declared preferences or browsing histories that are limited to specific devices or applications. These systems lack visibility into the broader context of how multiple devices interact within a network, thereby providing only partial insight into user activity or lifestyle. Moreover, existing advertisement delivery models often operate on fixed scheduling or demographic targeting, which fails to account for fluctuating network conditions, varying consumption behaviors, and real-time relevance of content. This leads to inefficiencies such as wasted bandwidth, reduced user engagement, and suboptimal advertisement conversion rates.

Another problem arises from the difficulty advertisers face in understanding the underlying factors that contribute to advertisement performance. Current analytics dashboards generally provide aggregated engagement metrics without deeper insights into the specific elements of content that drive effectiveness. This prevents sponsors from efficiently refining ad strategies or optimizing creative assets. Additionally, traditional systems do not integrate adaptive or learning-based decision mechanisms that continuously evolve advertisement targeting models in response to user feedback or performance data.

Further, challenges exist in managing advertisement data, user profiles, and engagement logs across distributed network infrastructures. Inconsistencies and synchronization delays in such systems can lead to errors in relevance determination and reward computation for user engagement. Issues of privacy and data protection also present technical limitations, as many existing systems rely on centralized data aggregation that may expose sensitive user information.

Therefore, there is a need for improved systems and methods for facilitating intelligent advertisement delivery based on network usage data that can overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating user-subsidized purchase of a product or a service based on active advertisement viewing. Further, the method may include receiving, using a communication device, an advertisement selection data from a client device. Further, the method may include receiving, using the communication device, an advertisement interaction data representing a user interaction with a selected advertisement from the client device. Further, the method may include determining, using a processing device, a point value associated with the advertisement interaction data. Further, the method may include accumulating, using a processing device, a total point data based on the point value. Further, the method may include storing, using a storage device, the total point data in association with a user account data. Further, the method may include transmitting, using the communication device, a credit data representing a redeemable value derived from the total point data to the client device.

The present disclosure provides a method of facilitating intelligent advertisement delivery based on network usage data. Further, the method may include receiving, using a communication device, a network usage data representing network consumption pattern of a client device from a router. Further, the method may include receiving, using the communication device, a device identification data representing a type and number of devices connected to the router. Further, the method may include determining, using a processing device, a lifestyle indicator data based on the network usage data and the device identification data. Further, the method may include generating, using the processing device, an advertisement catalogue data based on the lifestyle indicator data. Further, the method may include storing, using a storage device, the advertisement catalogue data in association with a user account data. Further, the method may include transmitting, using the communication device, the advertisement catalogue data to the client device for advertisement selection.

The present disclosure provides a system for facilitating user-subsidized purchase of a product or a service based on active advertisement viewing. Further, the system may include a communication device. Further, the communication device may be configured for receiving an advertisement selection data from a client device. Further, the communication device may be configured for receiving an advertisement interaction data representing a user interaction with a selected advertisement from the client device. Further, the communication device may be configured for transmitting a credit data representing a redeemable value derived from a total point data to the client device. Further, the system may include a processing device. Further, the processing device may be configured for determining a point value associated with the advertisement interaction data. Further, the processing device may be configured for accumulating the total point data based on the point value. Further, the system may include a storage device which may be configured for storing the total point data in association with a user account data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating user-subsidized purchase of a product or a service based on active advertisement viewing, in accordance with some embodiments.

FIG. 4 illustrates a flowchart of a method 400 of facilitating user-subsidized purchase of a product or a service based on active advertisement viewing including categorizing, using the processing device 2204, the advertisement selection data into a category data, in accordance with some embodiments.

FIG. 5 illustrates a flowchart of a method 500 of facilitating user-subsidized purchase of a product or a service based on active advertisement viewing including updating, using the processing device 2204, the total point data by adding the incremental point data, in accordance with some embodiments.

FIG. 6 illustrates a flowchart of a method 600 of facilitating user-subsidized purchase of a product or a service based on active advertisement viewing including adding, using the processing device 2204, the additional point value to the total point data, in accordance with some embodiments.

FIG. 7 illustrates a flowchart of a method 700 of facilitating user-subsidized purchase of a product or a service based on active advertisement viewing including converting, using the processing device 2204, the total point data into the credit data, in accordance with some embodiments.

FIG. 8 illustrates a flowchart of a method 800 of facilitating user-subsidized purchase of a product or a service based on active advertisement viewing including deleting, using the storage device 2206, the total point data when the current time data exceeds the expiration data, in accordance with some embodiments.

FIG. 9 illustrates a flowchart of a method 900 of facilitating user-subsidized purchase of a product or a service based on active advertisement viewing including applying, using the processing device 2204, the credit data to the payment record to offset a bill amount, in accordance with some embodiments.

FIG. 10 illustrates a flowchart of a method 1000 of facilitating user-subsidized purchase of a product or a service based on active advertisement viewing including generating, using the processing device 2204, an advertisement performance data, in accordance with some embodiments.

FIG. 11 illustrates a flowchart of a method 1100 of facilitating user-subsidized purchase of a product or a service based on active advertisement viewing including verifying, using the processing device 2204, a billing account data of an advertiser system, in accordance with some embodiments.

FIG. 12 illustrates a flowchart of a method 1200 of facilitating user-subsidized purchase of a product or a service based on active advertisement viewing, in accordance with some embodiments.

FIG. 13 illustrates a flowchart of a method 1300 of facilitating user-subsidized purchase of a product or a service based on active advertisement viewing including restricting, using the processing device 2204, transmission of a selected advertisement when the network usage data is below the network consumption threshold data, in accordance with some embodiments.

FIG. 14 illustrates a flowchart of a method 1400 of facilitating user-subsidized purchase of a product or a service based on active advertisement viewing including selecting, using the processing device 2204, a subset of advertisement catalogue data corresponding to the device-type profile data, in accordance with some embodiments.

FIG. 15 illustrates a flowchart of a method 1500 of facilitating user-subsidized purchase of a product or a service based on active advertisement viewing including predicting, using the processing device 2204, a purchase probability data, in accordance with some embodiments.

FIG. 16 illustrates a flowchart of a method 1600 of facilitating user-subsidized purchase of a product or a service based on active advertisement viewing including determining, using the processing device 2204, an advertisement relevance score for each advertisement using a machine learning model trained on user engagement data, in accordance with some embodiments.

FIG. 17 illustrates a flowchart of a method 1700 of facilitating user-subsidized purchase of a product or a service based on active advertisement viewing including approving or rejecting, using the processing device 2204, delivery of a corresponding advertisement, in accordance with some embodiments.

FIG. 18 illustrates a flowchart of a method 1800 of facilitating user-subsidized purchase of a product or a service based on active advertisement viewing including generating, using the processing device 2204, a dashboard data representing the engagement data, in accordance with some embodiments.

FIG. 19 illustrates a flowchart of a method 1900 of facilitating user-subsidized purchase of a product or a service based on active advertisement viewing including identifying, using the processing device 2204, a pattern data representing characteristics of high-performing advertisement content using an artificial intelligence model, in accordance with some embodiments.

FIG. 20 illustrates a flowchart of a method 2000 of facilitating user-subsidized purchase of a product or a service based on active advertisement viewing including updating, using the processing device 2204, the artificial intelligence model, in accordance with some embodiments.

FIG. 21 illustrates a flowchart of a method 2100 of facilitating user-subsidized purchase of a product or a service based on active advertisement viewing including generating, using the processing device 2204, an optimized advertisement delivery plan data, in accordance with some embodiments.

FIG. 22 illustrates a block diagram of the system 2200 of facilitating user-subsidized purchase of a product or a service based on active advertisement viewing, in accordance with some embodiments.

FIG. 23 illustrates an exemplary system 2300 of an advertisement-based reward and redemption platform, in accordance with some embodiments.

FIG. 24 illustrates an exemplary system 2400 of a network-based advertisement reward and redemption platform, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

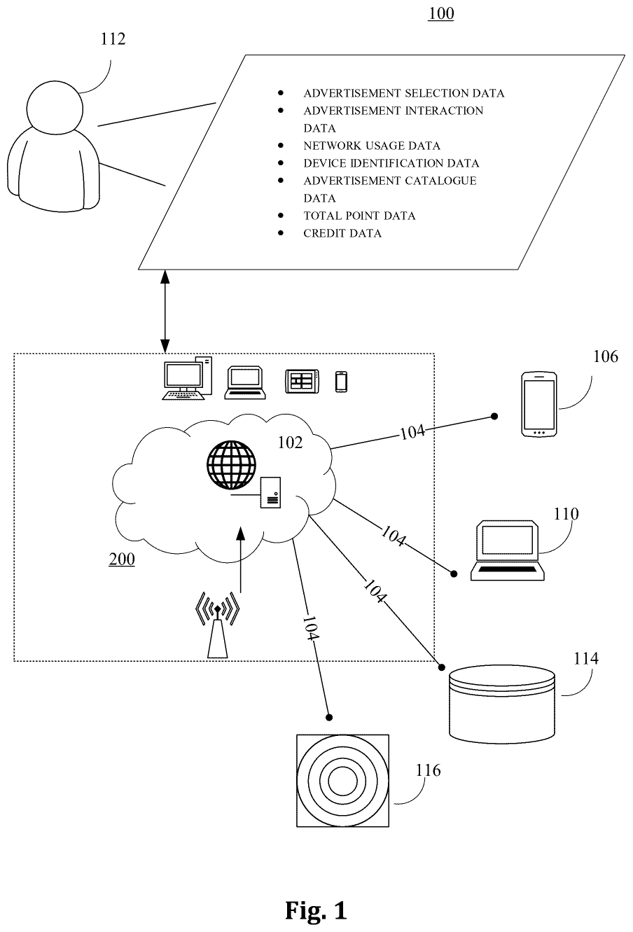

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

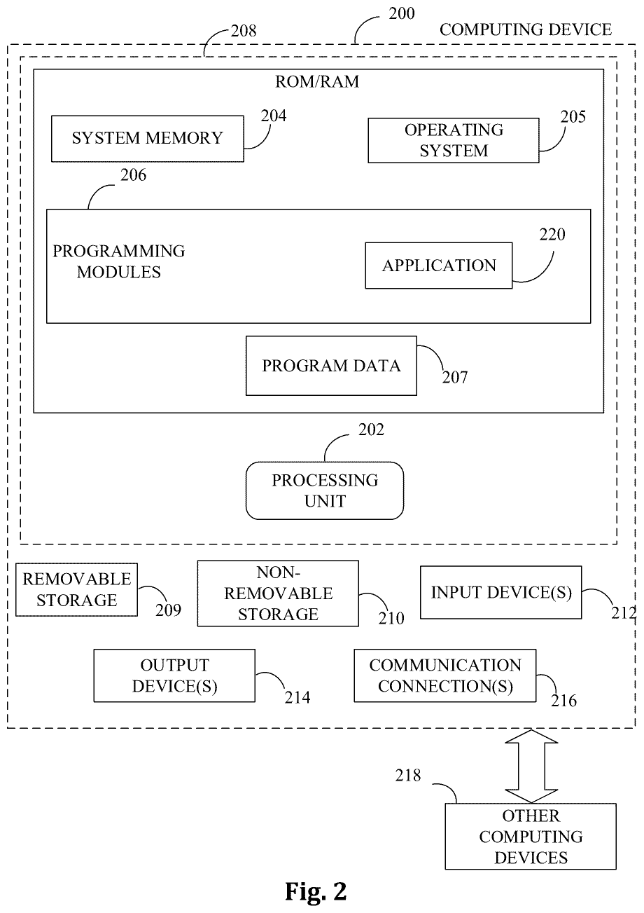

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

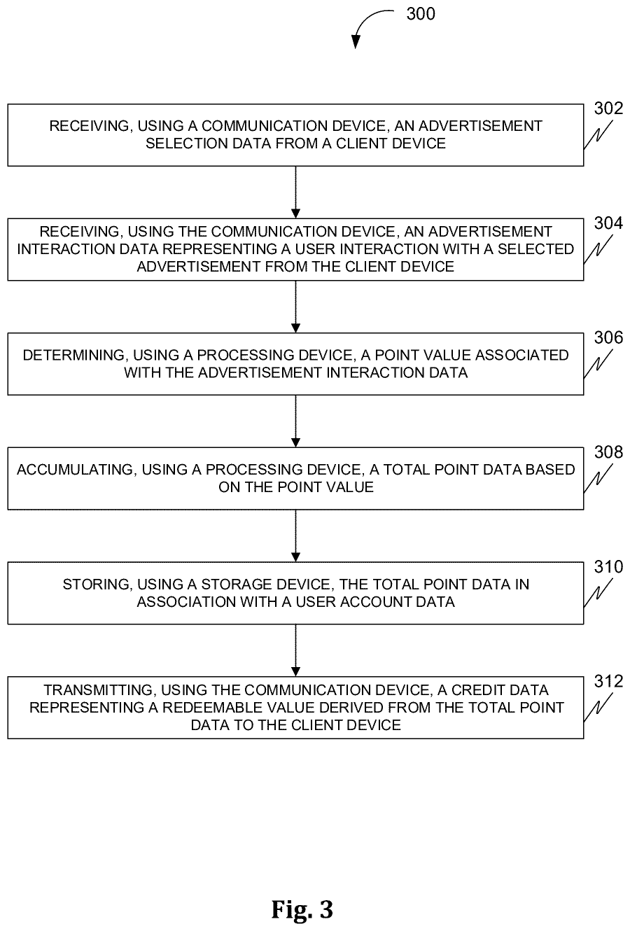

FIG. 3 illustrates a flowchart of a method 300 of facilitating user-subsidized purchase of a product or a service based on active advertisement viewing, in accordance with some embodiments.

Accordingly, the method 300 may include a step 302 of receiving, using a communication device 2202, an advertisement selection data from a client device. Further, the method 300 may include a step 304 of receiving, using the communication device 2202, an advertisement interaction data representing a user interaction with a selected advertisement from the client device. Further, the method 300 may include a step 306 of determining, using a processing device 2204, a point value associated with the advertisement interaction data. Further, the method 300 may include a step 308 of accumulating, using a processing device 2204, a total point data based on the point value. Further, the method 300 may include a step 310 of storing, using a storage device 2206, the total point data in association with a user account data. Further, the method 300 may include a step 312 of transmitting, using the communication device 2202, a credit data representing a redeemable value derived from the total point data to the client device.

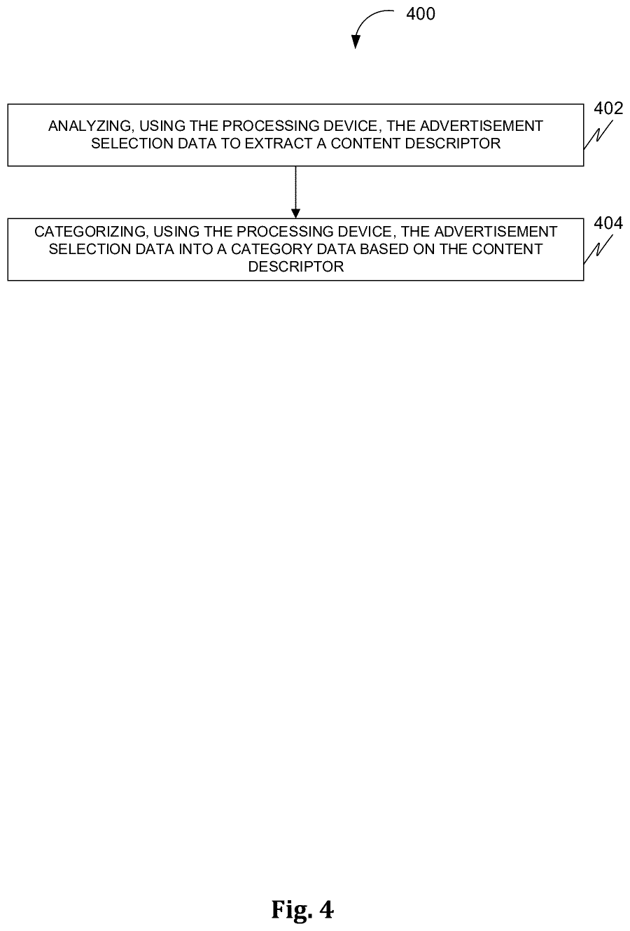

FIG. 4 illustrates a flowchart of a method 400 of facilitating user-subsidized purchase of a product or a service based on active advertisement viewing including categorizing, using the processing device 2204, the advertisement selection data into a category data, in accordance with some embodiments.

Further, in some embodiments, the method 400, further may include a step 402 of analyzing, using the processing device 2204, the advertisement selection data to extract a content descriptor. Further, in some embodiments, the method 400, further may include a step 404 of categorizing, using the processing device 2204, the advertisement selection data into a category data based on the content descriptor.

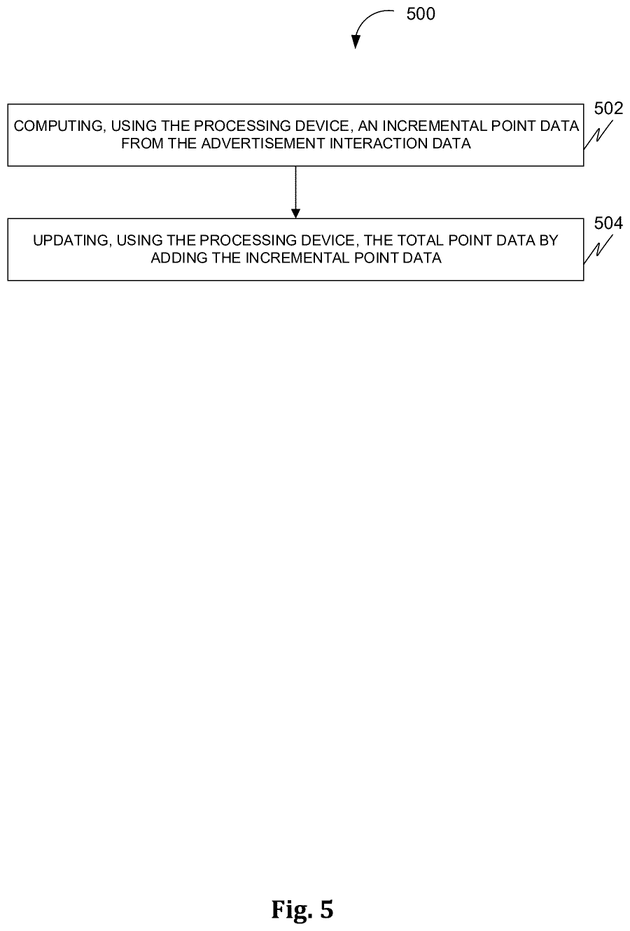

FIG. 5 illustrates a flowchart of a method 500 of facilitating user-subsidized purchase of a product or a service based on active advertisement viewing including updating, using the processing device 2204, the total point data by adding the incremental point data, in accordance with some embodiments.

Further, in some embodiments, the method 500, further may include a step 502 of computing, using the processing device 2204, an incremental point data from the advertisement interaction data. Further, in some embodiments, the method 500, further may include a step 504 of updating, using the processing device 2204, the total point data by adding the incremental point data.

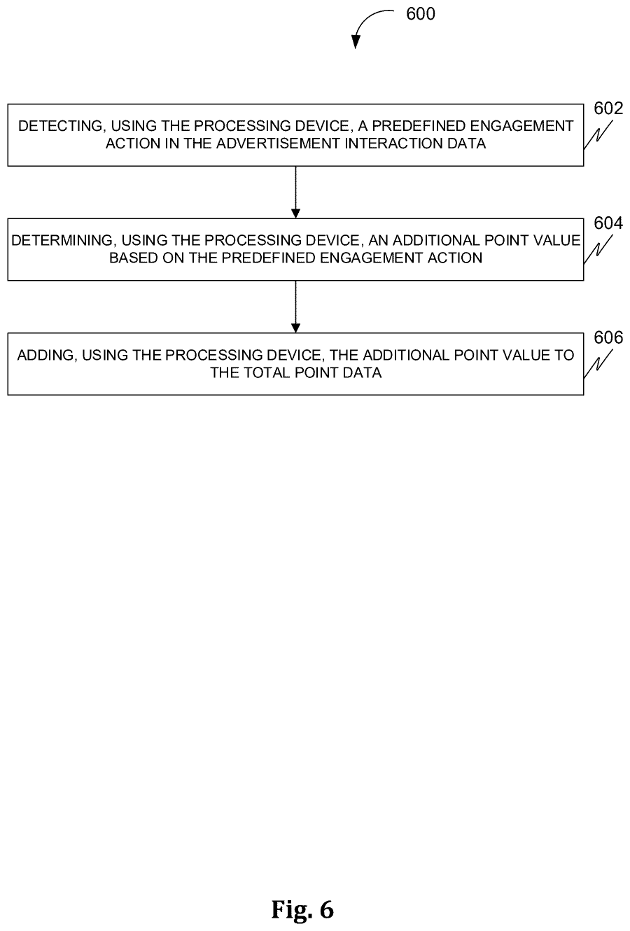

FIG. 6 illustrates a flowchart of a method 600 of facilitating user-subsidized purchase of a product or a service based on active advertisement viewing including adding, using the processing device 2204, the additional point value to the total point data, in accordance with some embodiments.

Further, in some embodiments, the method 600, further may include a step 602 of detecting, using the processing device 2204, a predefined engagement action in the advertisement interaction data. Further, in some embodiments, the method 600, further may include a step 604 of determining, using the processing device 2204, an additional point value based on the predefined engagement action. Further, in some embodiments, the method 600, further may include a step 606 of adding, using the processing device 2204, the additional point value to the total point data.

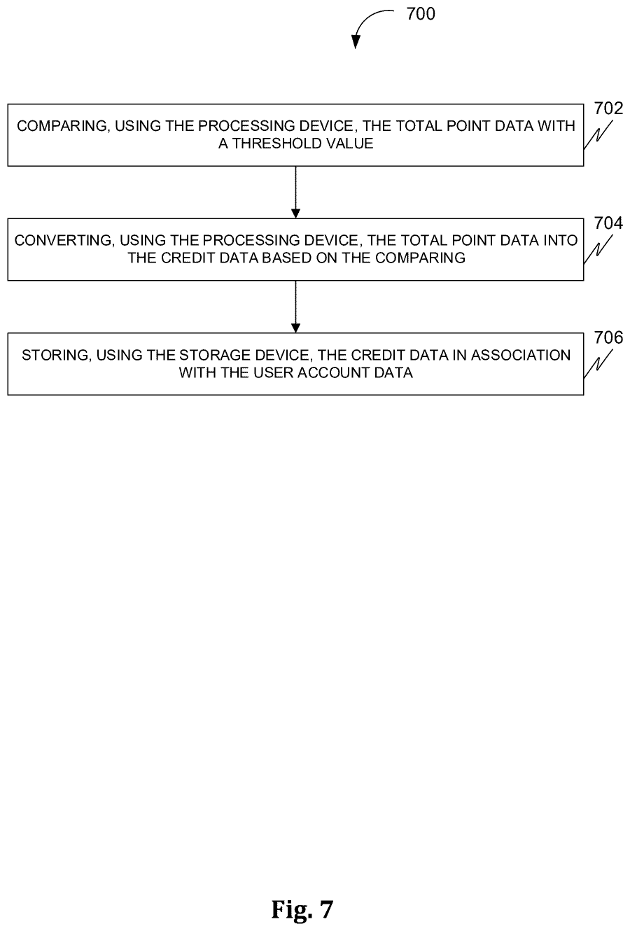

FIG. 7 illustrates a flowchart of a method 700 of facilitating user-subsidized purchase of a product or a service based on active advertisement viewing including converting, using the processing device 2204, the total point data into the credit data, in accordance with some embodiments.

Further, in some embodiments, the method 700, further may include a step 702 of comparing, using the processing device 2204, the total point data with a threshold value. Further, in some embodiments, the method 700, further may include a step 704 of converting, using the processing device 2204, the total point data into the credit data based on the comparing. Further, in some embodiments, the method 700, further may include a step 706 of storing, using the storage device 2206, the credit data in association with the user account data.

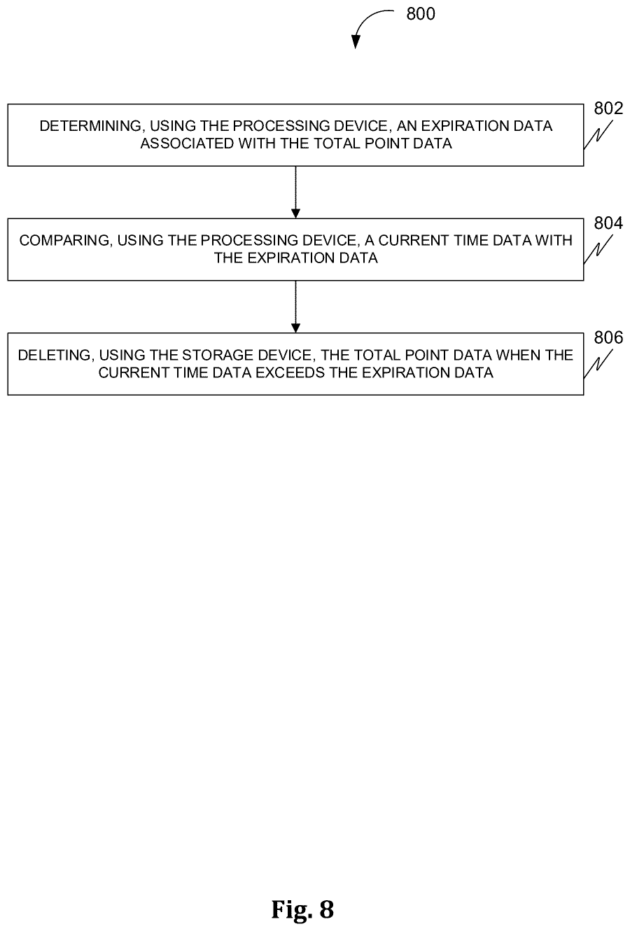

FIG. 8 illustrates a flowchart of a method 800 of facilitating user-subsidized purchase of a product or a service based on active advertisement viewing including deleting, using the storage device 2206, the total point data when the current time data exceeds the expiration data, in accordance with some embodiments.

Further, in some embodiments, the method 800, further may include a step 802 of determining, using the processing device 2204, an expiration data associated with the total point data. Further, in some embodiments, the method 800, further may include a step 804 of comparing, using the processing device 2204, a current time data with the expiration data. Further, in some embodiments, the method 800, further may include a step 806 of deleting, using the storage device 2206, the total point data when the current time data exceeds the expiration data.

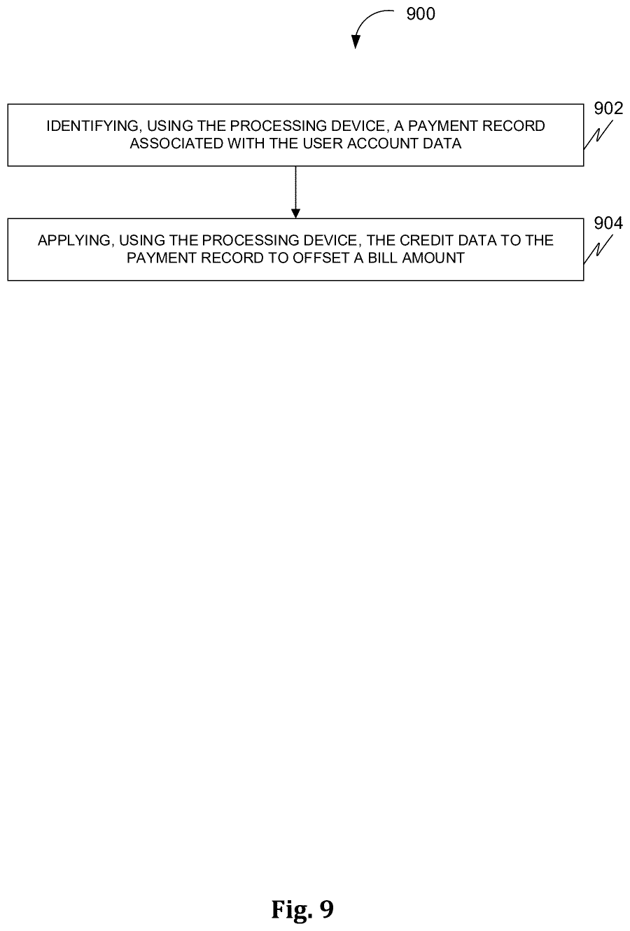

FIG. 9 illustrates a flowchart of a method 900 of facilitating user-subsidized purchase of a product or a service based on active advertisement viewing including applying, using the processing device 2204, the credit data to the payment record to offset a bill amount, in accordance with some embodiments.

Further, in some embodiments, the method 900, further may include a step 902 of identifying, using the processing device 2204, a payment record associated with the user account data. Further, in some embodiments, the method 900, further may include a step 904 of applying, using the processing device 2204, the credit data to the payment record to offset a bill amount.

In some embodiments, the client device includes one of a mobile device, a web device, or a television device capable of transmitting the advertisement selection data to the communication device 2202. Further, the communication device 2202 may be configured for receiving the advertisement selection data through a network connection.

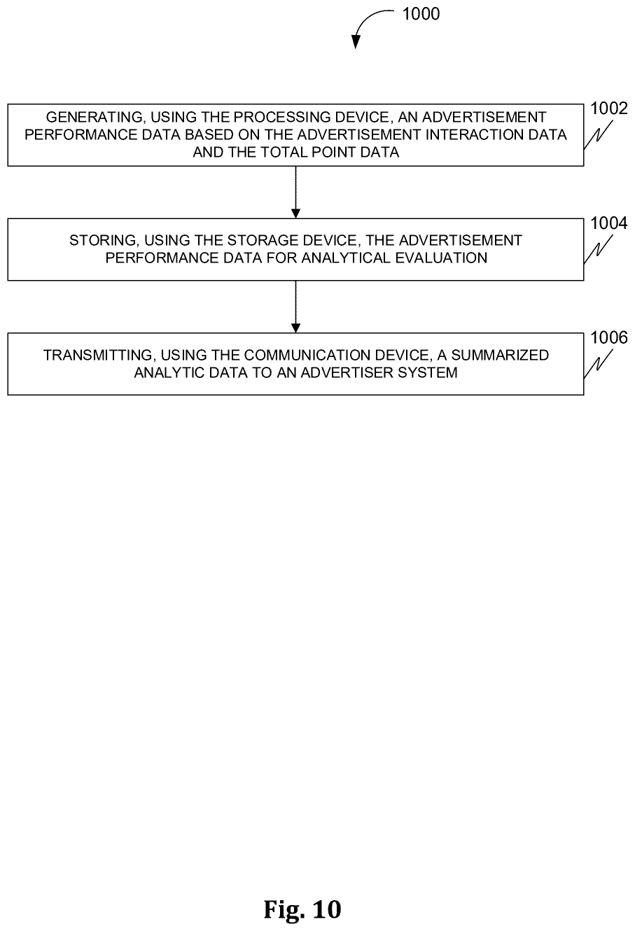

FIG. 10 illustrates a flowchart of a method 1000 of facilitating user-subsidized purchase of a product or a service based on active advertisement viewing including generating, using the processing device 2204, an advertisement performance data, in accordance with some embodiments.

Further, in some embodiments, the method 1000, further may include a step 1002 of generating, using the processing device 2204, an advertisement performance data based on the advertisement interaction data and the total point data. Further, in some embodiments, the method 1000, further may include a step 1004 of storing, using the storage device 2206, the advertisement performance data for analytical evaluation. Further, in some embodiments, the method 1000, further may include a step 1006 of transmitting, using the communication device 2202, a summarized analytic data to an advertiser system.

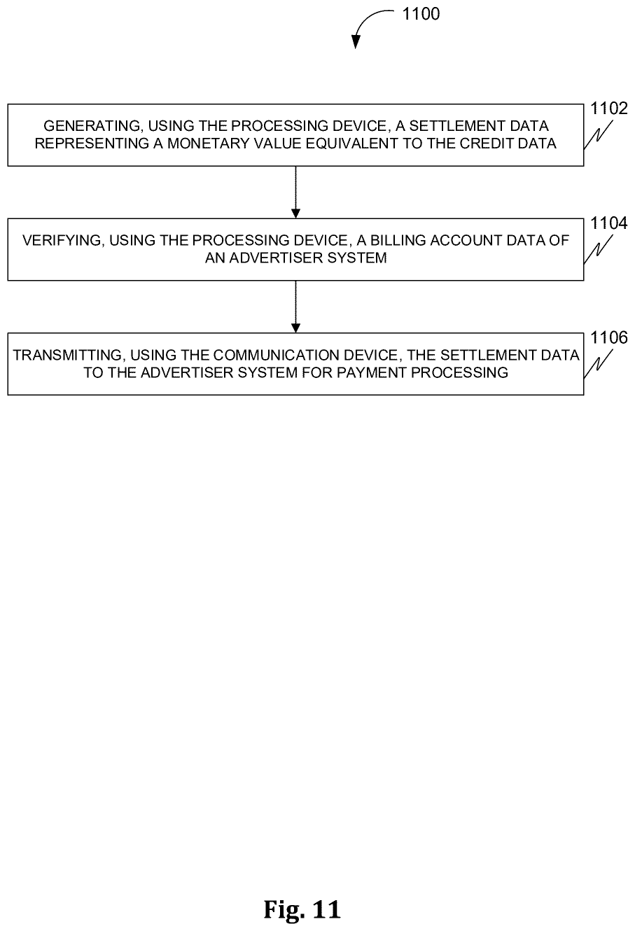

FIG. 11 illustrates a flowchart of a method 1100 of facilitating user-subsidized purchase of a product or a service based on active advertisement viewing including verifying, using the processing device 2204, a billing account data of an advertiser system, in accordance with some embodiments.

Further, in some embodiments, the method 1100, further may include a step 1102 of generating, using the processing device 2204, a settlement data representing a monetary value equivalent to the credit data. Further, in some embodiments, the method 1100, further may include a step 1104 of verifying, using the processing device 2204, a billing account data of an advertiser system. Further, in some embodiments, the method 1100, further may include a step 1106 of transmitting, using the communication device 2202, the settlement data to the advertiser system for payment processing.

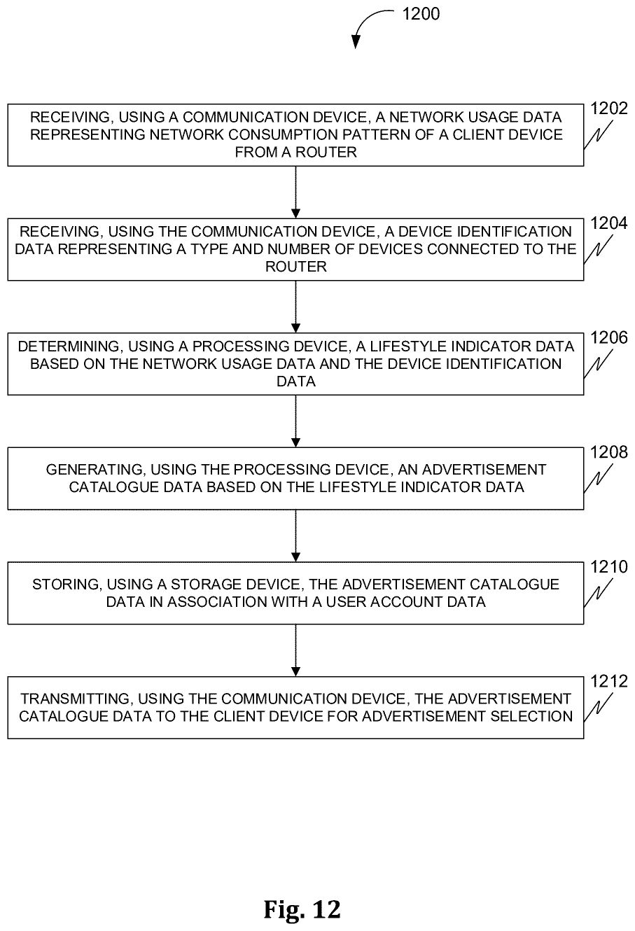

FIG. 12 illustrates a flowchart of a method 1200 of facilitating user-subsidized purchase of a product or a service based on active advertisement viewing, in accordance with some embodiments.

Accordingly, the method 1200 may include a step 1202 of receiving, using a communication device 2202, a network usage data representing network consumption pattern of a client device from a router. Further, the method 1200 may include a step 1204 of receiving, using the communication device 2202, a device identification data representing a type and number of devices connected to the router. Further, the method 1200 may include a step 1206 of determining, using a processing device 2204, a lifestyle indicator data based on the network usage data and the device identification data. Further, the method 1200 may include a step 1208 of generating, using the processing device 2204, an advertisement catalogue data based on the lifestyle indicator data. Further, the method 1200 may include a step 1210 of storing, using a storage device 2206, the advertisement catalogue data in association with a user account data. Further, the method 1200 may include a step 1212 of transmitting, using the communication device 2202, the advertisement catalogue data to the client device for advertisement selection.

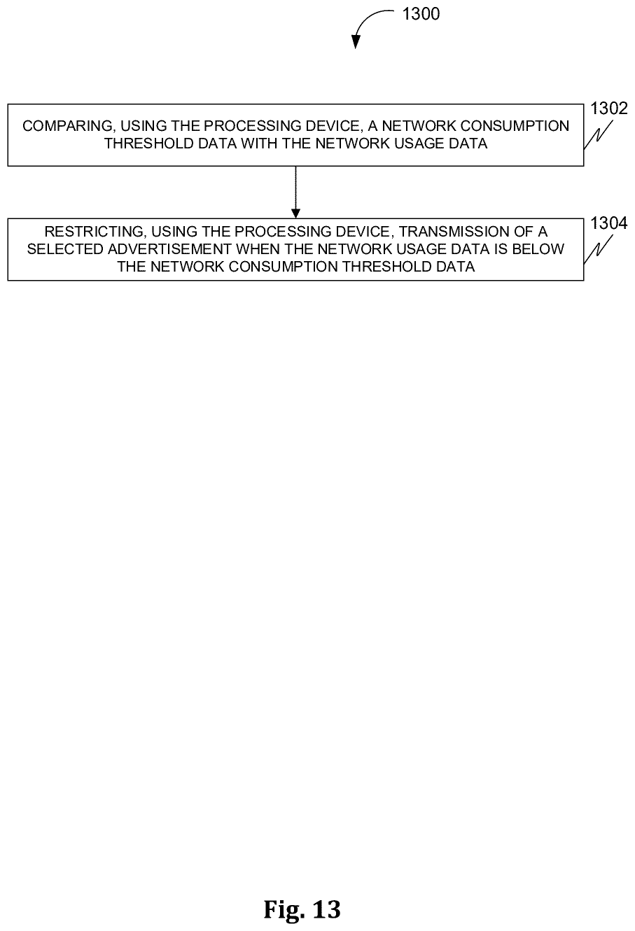

FIG. 13 illustrates a flowchart of a method 1300 of facilitating user-subsidized purchase of a product or a service based on active advertisement viewing including restricting, using the processing device 2204, transmission of a selected advertisement when the network usage data is below the network consumption threshold data, in accordance with some embodiments.

Further, in some embodiments, the method 1300, further may include a step 1302 of comparing, using the processing device 2204, a network consumption threshold data with the network usage data. Further, in some embodiments, the method 1300, further may include a step 1304 of restricting, using the processing device 2204, transmission of a selected advertisement when the network usage data may be below the network consumption threshold data.

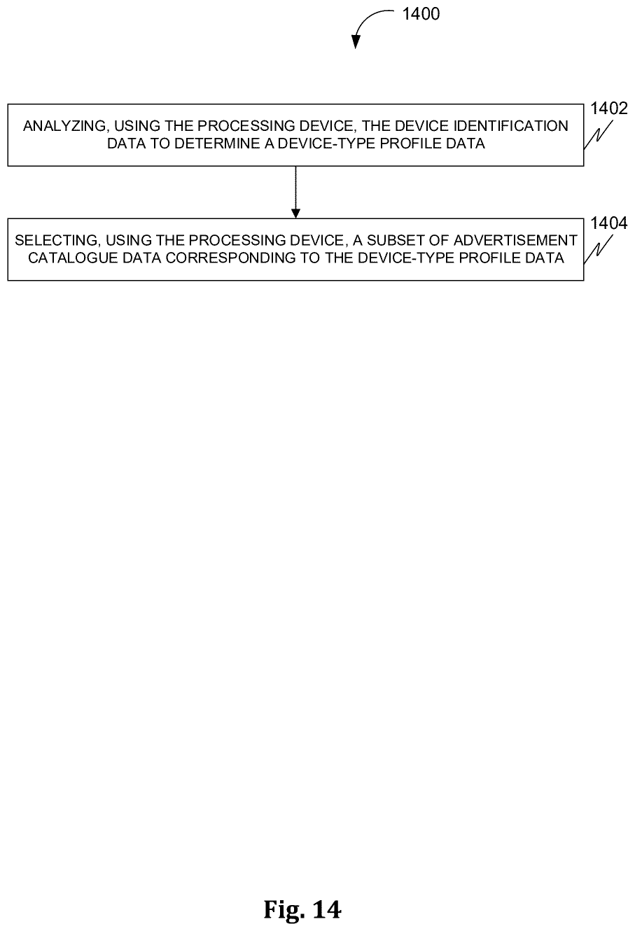

FIG. 14 illustrates a flowchart of a method 1400 of facilitating user-subsidized purchase of a product or a service based on active advertisement viewing including selecting, using the processing device 2204, a subset of advertisement catalogue data corresponding to the device-type profile data, in accordance with some embodiments.

Further, in some embodiments, the method 1400, further may include a step 1402 of analyzing, using the processing device 2204, the device identification data to determine a device-type profile data. Further, in some embodiments, the method 1400, further may include a step 1404 of selecting, using the processing device 2204, a subset of advertisement catalogue data corresponding to the device-type profile data.

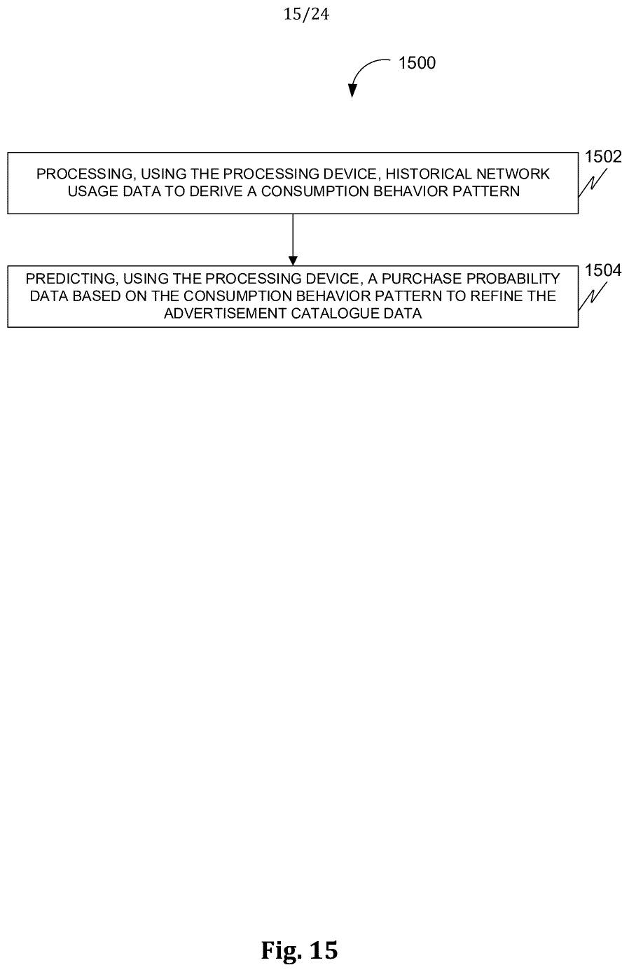

FIG. 15 illustrates a flowchart of a method 1500 of facilitating user-subsidized purchase of a product or a service based on active advertisement viewing including predicting, using the processing device 2204, a purchase probability data, in accordance with some embodiments.

Further, in some embodiments, the method 1500, further may include a step 1502 of processing, using the processing device 2204, historical network usage data to derive a consumption behavior pattern. Further, in some embodiments, the method 1500, further may include a step 1504 of predicting, using the processing device 2204, a purchase probability data based on the consumption behavior pattern to refine the advertisement catalogue data.

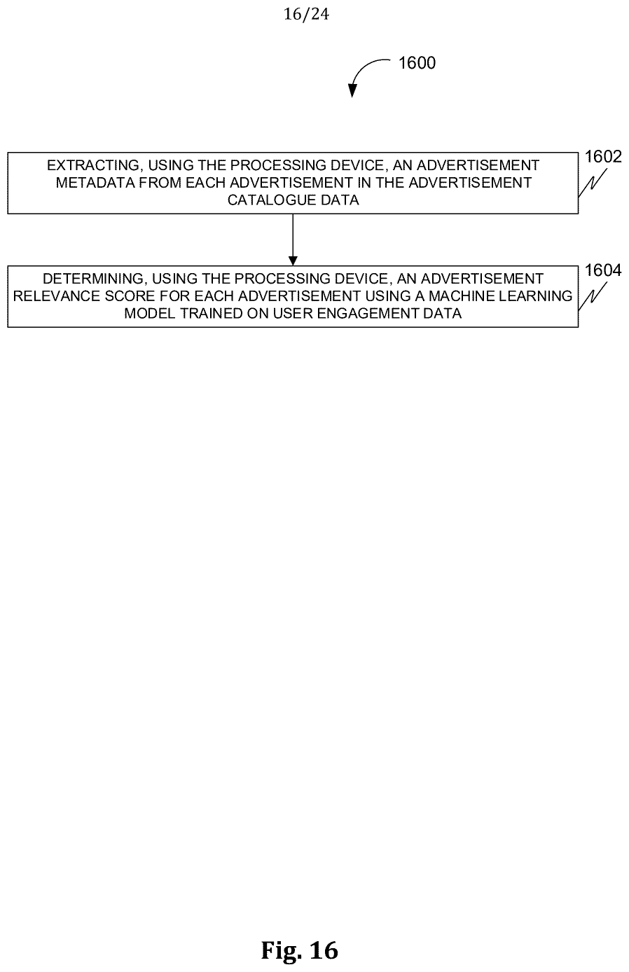

FIG. 16 illustrates a flowchart of a method 1600 of facilitating user-subsidized purchase of a product or a service based on active advertisement viewing including determining, using the processing device 2204, an advertisement relevance score for each advertisement using a machine learning model trained on user engagement data, in accordance with some embodiments.

Further, in some embodiments, the method 1600, further may include a step 1602 of extracting, using the processing device 2204, an advertisement metadata from each advertisement in the advertisement catalogue data. Further, in some embodiments, the method 1600, further may include a step 1604 of determining, using the processing device 2204, an advertisement relevance score for each advertisement using a machine learning model trained on user engagement data.

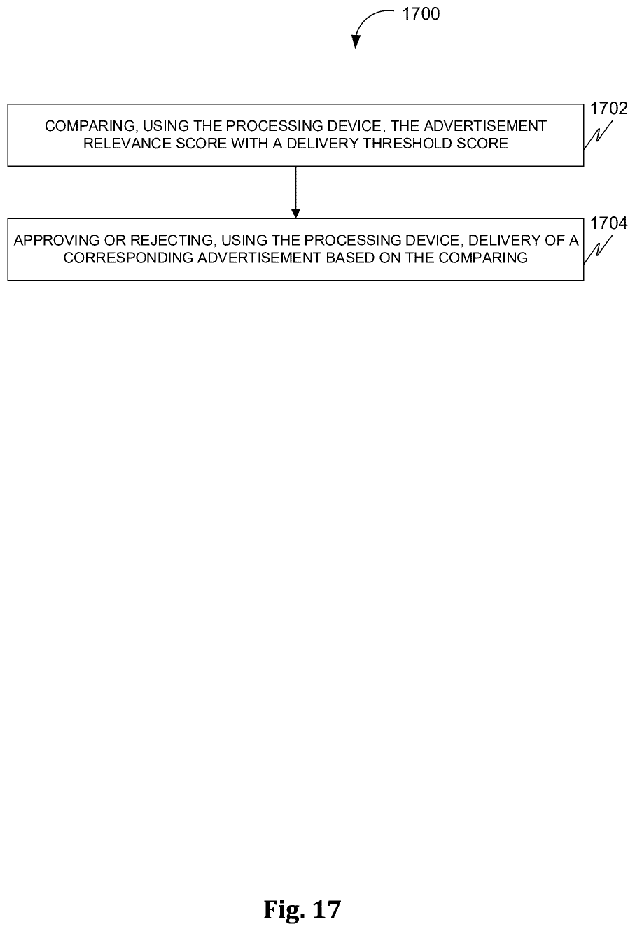

FIG. 17 illustrates a flowchart of a method 1700 of facilitating user-subsidized purchase of a product or a service based on active advertisement viewing including approving or rejecting, using the processing device 2204, delivery of a corresponding advertisement, in accordance with some embodiments.

Further, in some embodiments, the method 1700, further may include a step 1702 of comparing, using the processing device 2204, the advertisement relevance score with a delivery threshold score. Further, in some embodiments, the method 1700, further may include a step 1704 of approving or rejecting, using the processing device 2204, delivery of a corresponding advertisement based on the comparing.

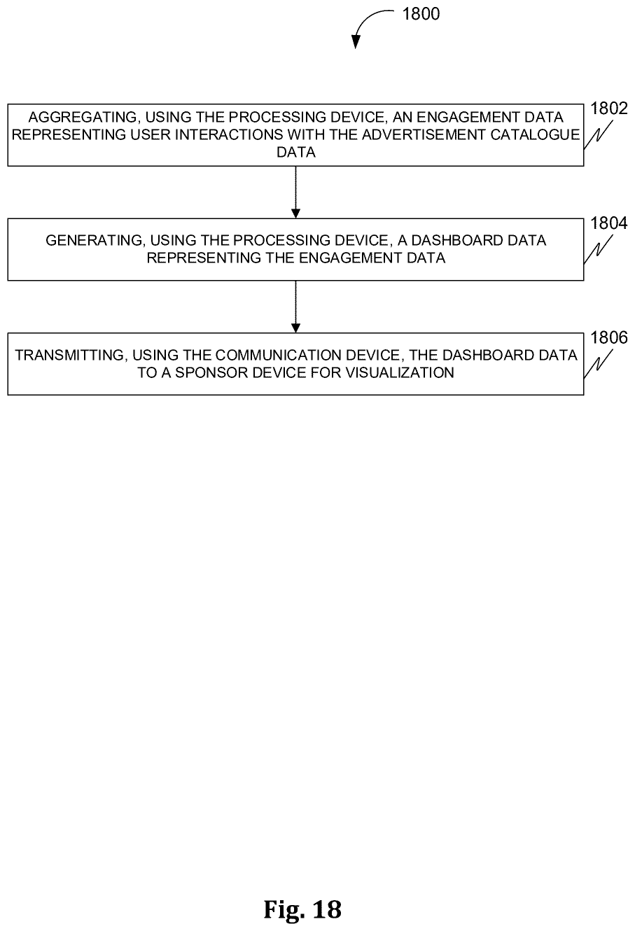

FIG. 18 illustrates a flowchart of a method 1800 of facilitating user-subsidized purchase of a product or a service based on active advertisement viewing including generating, using the processing device 2204, a dashboard data representing the engagement data, in accordance with some embodiments.

Further, in some embodiments, the method 1800, further may include a step 1802 of aggregating, using the processing device 2204, an engagement data representing user interactions with the advertisement catalogue data. Further, in some embodiments, the method 1800, further may include a step 1804 of generating, using the processing device 2204, a dashboard data representing the engagement data. Further, in some embodiments, the method 1800, further may include a step 1806 of transmitting, using the communication device 2202, the dashboard data to a sponsor device for visualization.

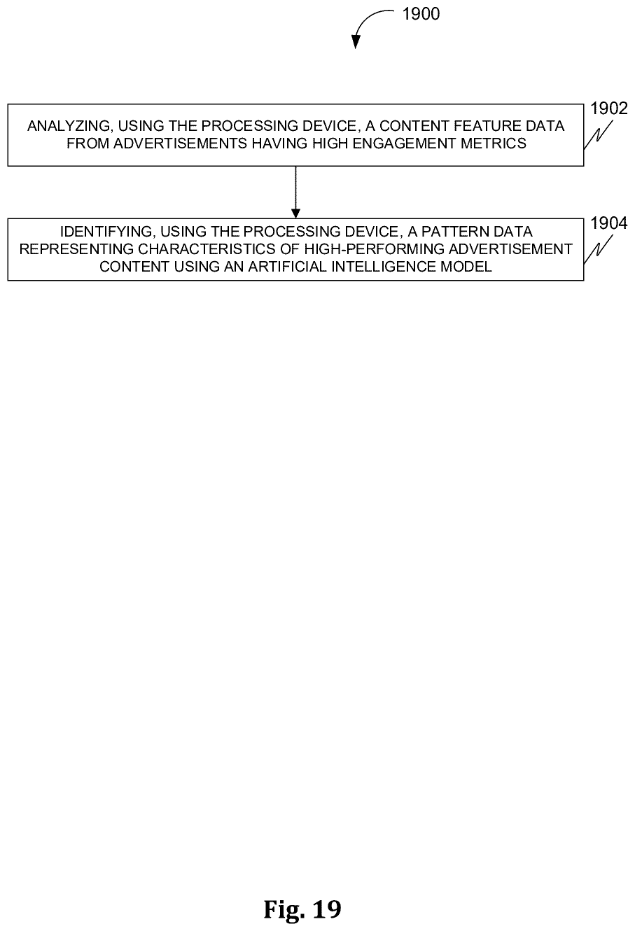

FIG. 19 illustrates a flowchart of a method 1900 of facilitating user-subsidized purchase of a product or a service based on active advertisement viewing including identifying, using the processing device 2204, a pattern data representing characteristics of high-performing advertisement content using an artificial intelligence model, in accordance with some embodiments.

Further, in some embodiments, the method 1900, further may include a step 1902 of analyzing, using the processing device 2204, a content feature data from advertisements having high engagement metrics. Further, in some embodiments, the method 1900, further may include a step 1904 of identifying, using the processing device 2204, a pattern data representing characteristics of high-performing advertisement content using an artificial intelligence model.

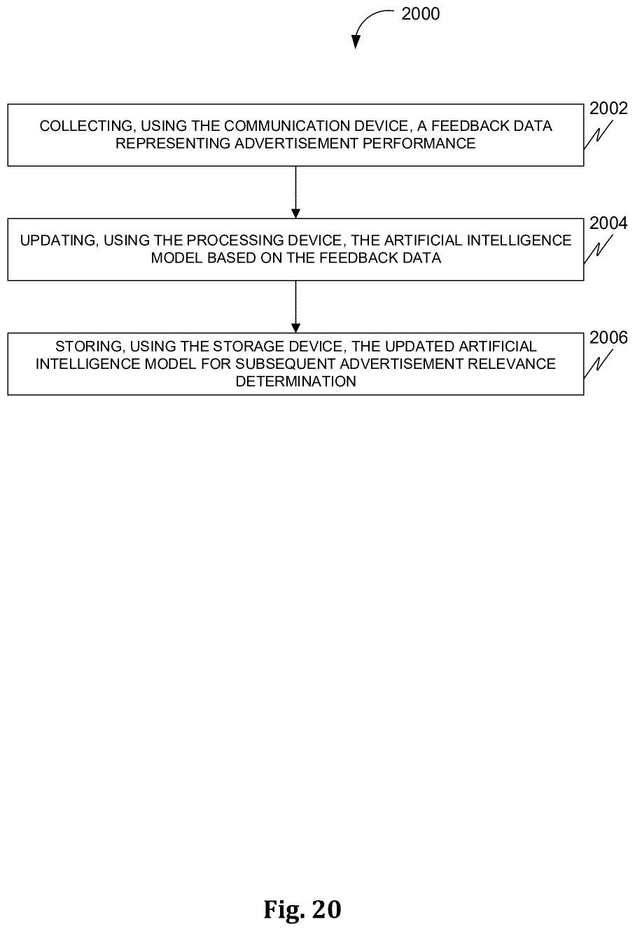

FIG. 20 illustrates a flowchart of a method 2000 of facilitating user-subsidized purchase of a product or a service based on active advertisement viewing including updating, using the processing device 2204, the artificial intelligence model, in accordance with some embodiments.

Further, in some embodiments, the method 2000, further may include a step 2002 of collecting, using the communication device 2202, a feedback data representing advertisement performance. Further, in some embodiments, the method 2000, further may include a step 2004 of updating, using the processing device 2204, the artificial intelligence model based on the feedback data. Further, in some embodiments, the method 2000, further may include a step 2006 of storing, using the storage device 2206, the updated artificial intelligence model for subsequent advertisement relevance determination.

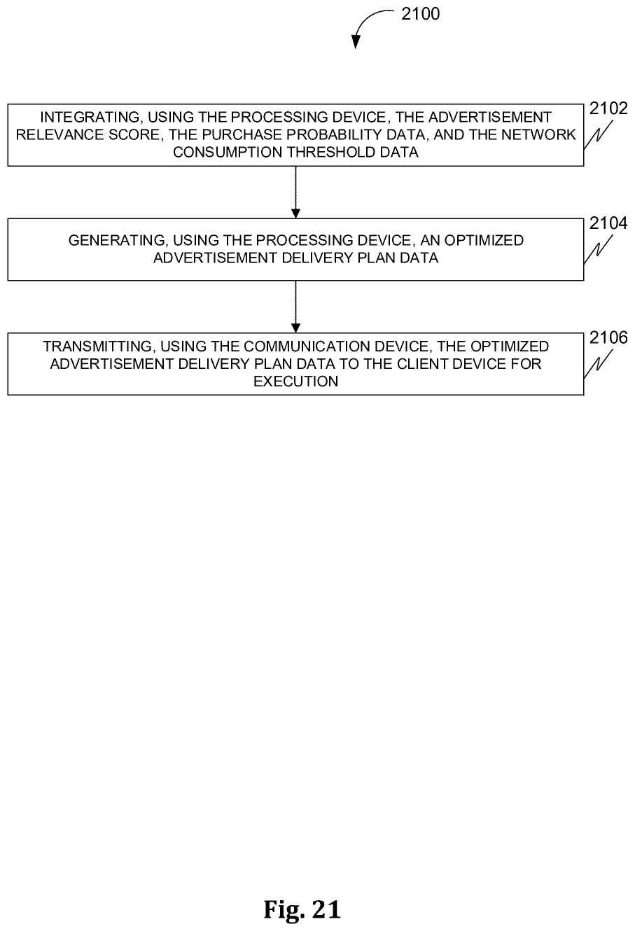

FIG. 21 illustrates a flowchart of a method 2100 of facilitating user-subsidized purchase of a product or a service based on active advertisement viewing including generating, using the processing device 2204, an optimized advertisement delivery plan data, in accordance with some embodiments.

Further, in some embodiments, the method 2100, further may include a step 2102 of integrating, using the processing device 2204, the advertisement relevance score, the purchase probability data, and the network consumption threshold data. Further, in some embodiments, the method 2100, further may include a step 2104 of generating, using the processing device 2204, an optimized advertisement delivery plan data. Further, in some embodiments, the method 2100, further may include a step 2106 of transmitting, using the communication device 2202, the optimized advertisement delivery plan data to the client device for execution.

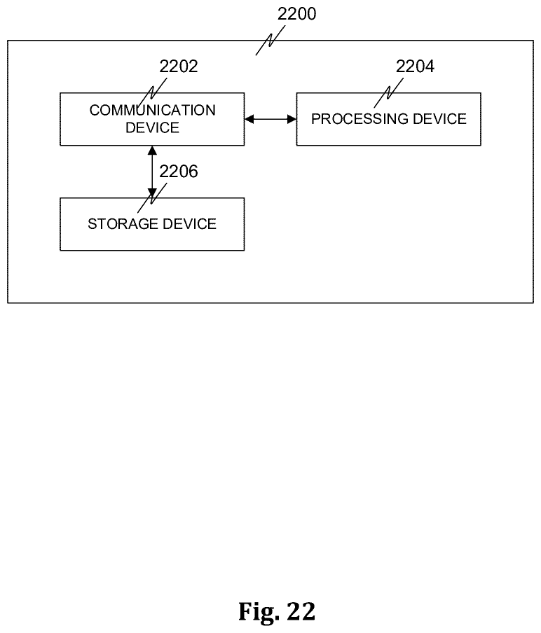

FIG. 22 illustrates a block diagram of the system 2200 of facilitating user-subsidized purchase of a product or a service based on active advertisement viewing, in accordance with some embodiments.

Accordingly, the system 2200 may include a communication device 2202. Further, the communication device 2202 may be configured for receiving an advertisement selection data from a client device. Further, the communication device 2202 may be configured for receiving an advertisement interaction data representing a user interaction with a selected advertisement from the client device. Further, the communication device 2202 may be configured for transmitting a credit data representing a redeemable value derived from a total point data to the client device. Further, the system 2200 may include a processing device 2204. Further, the processing device 2204 may be configured for determining a point value associated with the advertisement interaction data. Further, the processing device 2204 may be configured for accumulating the total point data based on the point value. Further, the system 2200 may include a storage device 2206 which may be configured for storing the total point data in association with a user account data.

Further, in some embodiments, the processing device 2204 may be further configured for analyzing the advertisement selection data to extract a content descriptor. Further, the processing device 2204 may be further configured for categorizing the advertisement selection data into a category data based on the content descriptor.

Further, in some embodiments, the processing device 2204 may be further configured for computing an incremental point data from the advertisement interaction data. Further, the processing device 2204 may be further configured for updating the total point data by adding the incremental point data.

Further, in some embodiments, the processing device 2204 may be further configured for detecting a predefined engagement action in the advertisement interaction data. Further, the processing device 2204 may be further configured for determining an additional point value based on the predefined engagement action. Further, the processing device 2204 may be further configured for adding the additional point value to the total point data.

Further, in some embodiments, the processing device 2204 may be further configured for comparing the total point data with a threshold value. Further, the processing device 2204 may be further configured for converting the total point data into the credit data based on the comparing. Further, the storage device 2206 may be further configured for storing the credit data in association with the user account data.

Further, in some embodiments, the processing device 2204 may be further configured for determining an expiration data associated with the total point data. Further, the processing device 2204 may be further configured for comparing a current time data with the expiration data. Further, the storage device 2206 may be further configured for deleting the total point data when the current time data exceeds the expiration data.

Further, in some embodiments, the processing device 2204 may be further configured for identifying a payment record associated with the user account data. Further, the processing device 2204 may be further configured for applying the credit data to the payment record to offset a bill amount.

In some embodiments, the client device includes one of a mobile device, a web device, or a television device capable of transmitting the advertisement selection data to the communication device 2202. Further, the communication device 2202 may be configured for receiving the advertisement selection data through a network connection.

In some embodiments, the processing device 2204 may be further configured for generating an advertisement performance data based on the advertisement interaction data and the total point data. Further, the communication device 2202 may be further configured for transmitting a summarized analytic data to an advertiser system, may. Further, the storage device 2206 may be further configured for storing the advertisement performance data for analytical evaluation.

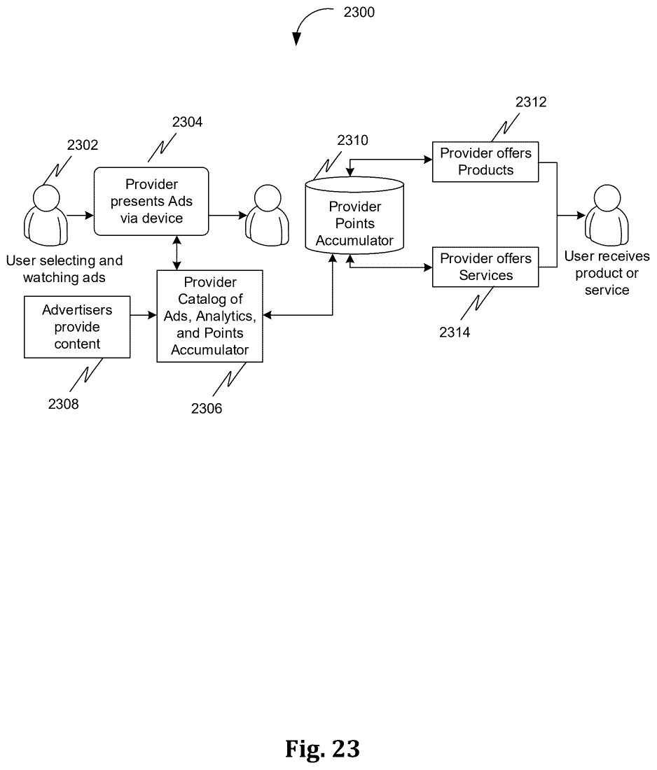

Referring now to FIG. 23, an exemplary system 2300 is illustrated that depicts the operational flow of a provider-managed advertisement-driven reward and redemption platform. The system may be implemented as a network-based infrastructure that enables users to view advertisements, accumulate reward points based on viewership and engagement, and redeem such points for products or services offered by a provider.

In some embodiments, the system 2300 may include a user 2302, a provider presentation module 2304, a provider catalog module 2306, an advertiser content source 2308, a provider points accumulator 2310, a provider product offering module 2312, and a provider service offering module 2314. Each of these components may communicate with one another through one or more communication networks using secure and authenticated communication protocols.

In operation, the advertisers 2308 may provide advertisement content to the provider catalog of ads, analytics, and points accumulator 2306. The catalog may include metadata related to advertisement content, such as duration, category, advertiser identity, and engagement metrics. In some embodiments, the catalog may also maintain information related to point allocation policies that define how many reward points are assigned to each advertisement based on factors such as completion rate, click-throughs, or engagement actions.

The provider 2304 may then present one or more advertisements from the catalog to the user 2302 through a suitable device interface, which may include a mobile application, a web platform, or a connected television environment. The presentation may be managed dynamically based on advertisement selection algorithms that consider user preferences, viewing history, or demographic indicators. The user 2302, upon viewing or interacting with the advertisement, may generate engagement data that is transmitted back to the provider catalog module 2306 for tracking and analytics.

In some embodiments, the provider points accumulator 2310 may receive data from the catalog module 2306 corresponding to the user's viewing activity. The points accumulator may process this data to compute and store a cumulative total of reward points earned by each user account. The accumulation may be based on predetermined thresholds or variable weighting factors assigned to different advertisements. For example, advertisements requiring full playback or deeper interaction may yield higher reward point values than brief or passive viewing events.

The accumulated points may then be used to obtain products or services through the provider product offering module 2312 and the provider service offering module 2314, respectively. The product offering module 2312 may manage an inventory of tangible goods, while the service offering module 2314 may handle digital, subscription-based, or experience-based offerings. The user may select a desired product or service, and the corresponding point value may be deducted from the user's account balance maintained in the provider points accumulator 2310. Upon successful redemption, the user 2302 may receive the product or service through fulfillment channels coordinated by the provider.

In some embodiments, the system may also include data analytics capabilities that allow the provider to evaluate advertisement performance, user engagement patterns, and redemption trends. The provider catalog 2306 may operate in conjunction with the points accumulator 2310 to continuously refine advertisement selection strategies and point allocation schemes. For example, the system may adjust the reward value of certain advertisements in real time based on viewer response data, advertiser demand, or campaign objectives.

In certain implementations, advertisers 2308 may receive anonymized analytical reports generated from the data collected across the system 2300. Such reports may provide insights into ad effectiveness, viewer demographics, or behavioral correlations without exposing personally identifiable user data.

The described architecture thereby enables a closed-loop ecosystem wherein advertisers supply content, users engage with that content in exchange for redeemable value, and providers facilitate transactions for goods and services based on earned credits. This integrated model allows for improved user engagement, monetization efficiency, and transparency between stakeholders.

While FIG. 2300 illustrates one example configuration, variations may exist. In some embodiments, modules 2304, 2306, and 2310 may be implemented as virtualized components of a cloud-based SaaS infrastructure. In other embodiments, functions of the product and service modules 2312 and 2314 may be consolidated into a unified redemption management interface. Similarly, the analytics functions within the catalog module 2306 may be distributed across multiple servers to enhance scalability and performance.

Accordingly, FIG. 2300 represents a comprehensive functional diagram illustrating the data flow and interrelationship between system components in an advertisement-based reward and redemption platform that facilitates user-subsidized access to products and services through active advertisement participation.

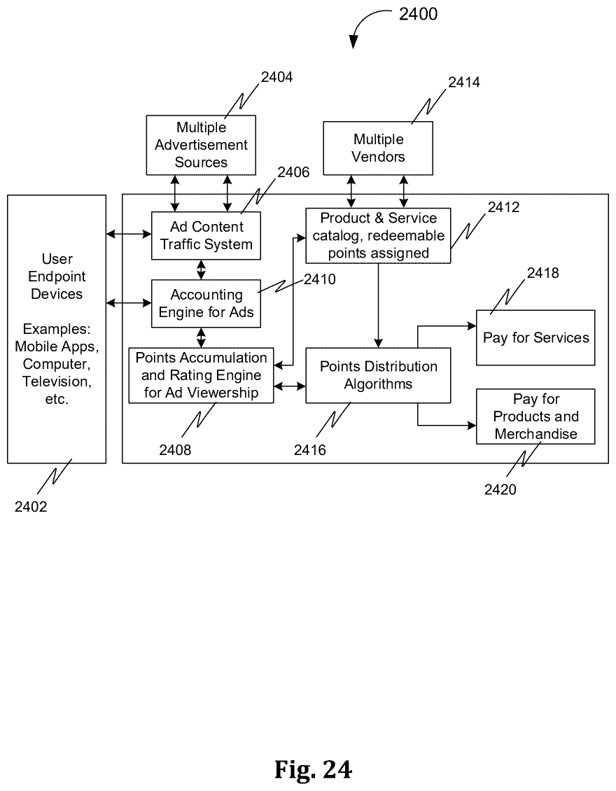

Referring now to FIG. 24, an exemplary system 2400 is illustrated that represents the operational framework of an advertisement-based reward and redemption system managed by a network service provider. The system enables users to access advertisements via endpoint devices, earn redeemable points based on advertisement viewership and engagement, and utilize those points to pay for products or services. The system further integrates multiple advertisement sources, vendors, and algorithmic components that ensure real-time accounting, rating, and distribution of rewards within a network-connected infrastructure.

In some embodiments, the system 2400 may include a plurality of interconnected components, including user endpoint devices 2402, multiple advertisement sources 2404, an ad content traffic system 2406, a points accumulation and rating engine for ad viewership 2408, an accounting engine for ads 2410, a product and service catalog 2412, multiple vendors 2414, points distribution algorithms 2416, and payment modules such as pay for services 2418 and pay for products and merchandise 2420. Each of these components may be implemented using one or more software modules, cloud-based servers, or distributed databases operating under the control of a network service provider.

In operation, user endpoint devices 2402—which may include mobile applications, computers, televisions, or other internet-enabled interfaces—serve as access points for users to interact with advertisements and the service provider's reward platform. Users may choose advertisements to view, interact with them, and accumulate engagement data transmitted to the provider's backend systems.

The multiple advertisement sources 2404 provide diverse ad content to the ad content traffic system 2406, which is responsible for routing, scheduling, and managing advertisement delivery to the appropriate endpoint devices. This traffic system may implement intelligent ad-serving protocols, ensuring that relevant advertisements are presented to users based on user category, available bandwidth, or behavioral analytics.

In some embodiments, the points accumulation and rating engine 2408 may track ad viewership data received from endpoint devices and assign corresponding points based on predefined engagement rules. These rules may take into account the duration of ad viewing, user interaction (such as clicks or shares), and ad completion percentage. The engine may then communicate the awarded points to the accounting engine for ads 2410, which performs verification, validation, and reconciliation of advertisement-related transactions between advertisers, vendors, and users.

The product and service catalog 2412 may contain a list of goods, services, and digital offerings available for redemption using accumulated points. Each entry in the catalog may have a corresponding redeemable point value, dynamically assigned and updated through the points distribution algorithms 2416. These algorithms may employ weighted parameters to balance the advertisement value, sponsor contributions, and product pricing structures.

The multiple vendors 2414 may include service providers, retailers, or merchants that have integrated their offerings into the system. Vendors may upload product and service data, including pricing and availability information, which the catalog 2412 references during redemption processes.

In operation, once a user has accumulated a sufficient number of points, the points distribution algorithms 2416 may determine how these points are allocated or converted into redemption credits. The system may use probabilistic or rules-based models to calculate the optimal point-to-currency ratio, ensuring fairness and maintaining equilibrium among advertisers, providers, and vendors.

The pay for services module 2418 and pay for products and merchandise module 2420 facilitate the redemption process. Upon successful point conversion, a user may utilize the accumulated points to directly pay for a service subscription, a digital asset, or a tangible product. These modules may interact with vendor-side payment gateways to authorize transactions using point-based credits rather than traditional currency payments.

In some embodiments, the system 2400 may further include advanced analytics and reporting functionalities embedded within the ad content traffic system 2406 and the accounting engine 2410. These analytics may provide insights into advertisement effectiveness, user engagement trends, and vendor transaction performance. For example, advertisers may receive feedback indicating which ad formats, durations, or delivery times result in higher engagement or conversion rates.

In other embodiments, the points accumulation and rating engine 2408 and points distribution algorithms 2416 may employ machine learning techniques to enhance the precision of engagement scoring and reward allocation. For instance, predictive models may estimate a user's likelihood to engage with a specific ad category, enabling the system to dynamically adjust reward levels to maximize engagement efficiency.

The system of FIG. 2400 thereby illustrates a comprehensive and closed-loop advertisement management and reward distribution ecosystem. Through the coordinated operation of content delivery, accounting, rating, and distribution modules, the system ensures that user engagement translates into tangible economic value within a self-sustaining network model. This structure benefits users by offering subsidized or free access to products and services, advertisers by ensuring targeted exposure, and vendors by facilitating consumer transactions driven by earned reward points.

In some implementations, the modules shown in FIG. 2400 may be hosted in a cloud environment as part of a Software-as-a-Service (SaaS) model operated by a network service provider. In other implementations, specific subsystems—such as the ad content traffic system 2406 or accounting engine 2410—may be deployed on-premises or at edge servers for reduced latency and enhanced data privacy. Alternative configurations may also consolidate the pay-for-services and pay-for-products modules into a unified digital wallet interface accessible via user endpoint devices.

Accordingly, FIG. 2400 provides a detailed schematic of an integrated advertisement viewership-based reward architecture that connects users, advertisers, and vendors through an intelligent, data-driven network platform facilitating advertisement delivery, engagement tracking, point accumulation, and redemption for goods and services.

Disclosed herein are technical improvements embodied by or applicable to a network-aware, AI-enhanced advertisement delivery system that intelligently selects, filters, and distributes advertisements based on network-level usage data, device profiling, and adaptive machine learning analytics. Unless explicitly stated otherwise, the word “embodiment” as used herein shall be interpreted broadly to include optional, alternative, or equivalent technical realizations. In some embodiments, any described feature may be implemented independently or in combination with other features to improve computational efficiency, personalization accuracy, or data processing speed within a distributed network service environment.

In some embodiments, the disclosure provides a network-level inference layer integrated within a service provider infrastructure that enables contextual awareness of user device activity, data throughput, and content consumption. Traditional advertisement platforms rely on browser cookies or user-declared interests, which are inherently limited to application-layer signals. The technical problem of lacking reliable behavioral indicators is addressed by embedding inference logic at the network layer. The system may include deep packet inspection (DPI)-free network telemetry, statistical flow analysis, or encrypted traffic pattern recognition that infers device activity signatures without breaching data privacy. For example, router-level metadata such as bandwidth spikes, packet timing, and device type may be processed using recurrent neural networks (RNNs) or transformer-based temporal encoders to derive a “lifestyle indicator” data vector. This feature improves network analytics technology, enabling cross-device contextual profiling directly within network infrastructure while preserving end-to-end encryption compliance.

In some embodiments, the disclosure may implement a dynamic advertisement catalogue generation engine that continuously synchronizes network-derived lifestyle indicators with a semantic advertisement repository. The technical problem addressed here is the static and batch-based nature of ad targeting systems, which cannot adapt to real-time user behavior. The system may employ vector embeddings generated from both advertisement content and lifestyle indicators to dynamically cluster relevant ads using online k-means or hierarchical density-based algorithms. In some embodiments, contextual similarity between an ad and a lifestyle vector may be computed using cosine similarity or contrastive loss-trained encoders. This improves ad recommendation system technology by enabling real-time personalization at the network edge.

In some embodiments, the disclosure may utilize an AI-based relevance scoring mechanism that adapts dynamically based on user engagement feedback. The technical problem addressed is that conventional machine learning models for ad ranking rely on static offline training, which results in stale relevance scoring. The disclosure may integrate federated learning or reinforcement learning-based adaptation where edge servers retrain lightweight neural models locally using engagement data (e.g., click-through rates, dwell times) and propagate updated gradients to a centralized model. This improves machine learning model adaptability technology, particularly for distributed recommendation frameworks operating over network infrastructure.

In some embodiments, the disclosure may include a context-aware ad delivery control mechanism that prevents inefficient advertisement transmission to low-usage or low-probability users. The technical problem is the waste of network bandwidth and advertiser spend on users with low likelihood of engagement. The system may implement a probabilistic gating model where delivery decisions are made using logistic regression or Bayesian inference that evaluates consumption thresholds, device connectivity patterns, and predicted purchase probability. For instance, a user with minimal internet activity or consistent low engagement scores may be temporarily excluded from ad delivery queues. This feature improves network traffic optimization technology by reducing unnecessary data transmission and improving resource allocation in bandwidth-constrained environments.

In some embodiments, the disclosure may include an AI-driven advertisement content analytics module that identifies high-performing ad characteristics based on multimodal data (image, text, and audio). The technical problem addressed is the absence of automated insights into what elements make an advertisement effective. The system may employ a multimodal transformer architecture such as CLIP (Contrastive Language- Image Pretraining) or its derivatives to analyze ad creatives, extract latent features, and correlate them with engagement metrics. The analysis may reveal patterns such as optimal tone, imagery composition, or color palette that correspond to higher user conversion rates. This improves advertising content optimization technology by introducing self-improving feedback loops for creative development.

In some embodiments, the disclosure provides a sponsor dashboard powered by explainable AI analytics, solving the problem of black-box machine learning decisions in ad targeting systems. The system may generate interpretable visualizations such as SHAP (SHapley Additive exPlanations) plots, attention heatmaps, or decision trees that illustrate why certain ads were delivered or why certain users were excluded. This improves human-AI interface technology by allowing advertisers to audit and trust automated decision pipelines.

In some embodiments, the disclosure may include a distributed storage synchronization layer for maintaining ad catalogue data, engagement data, and model parameters across multiple servers or edge routers. The technical problem of latency and data inconsistency across distributed caches is solved by employing conflict-free replicated data types (CRDTs) or blockchain-backed consensus protocols (such as PBFT or Raft variants). This improvement enhances distributed data synchronization technology, ensuring consistent real-time advertisement personalization across geographically dispersed nodes.

In some embodiments, the disclosure may also include an automated feedback-driven reinforcement framework where the advertisement delivery policy is periodically optimized through reinforcement signals derived from conversion events. The system may use actor-critic or policy-gradient architectures to iteratively refine its decision-making models. This improves reinforcement learning integration technology within service-provider-scale advertising systems.

In some embodiments, the disclosure may include a privacy-preserving federated analytics engine that performs on-device training of user engagement models, solving the technical problem of user data exposure in centralized AI systems. Techniques such as secure multiparty computation (SMC), differential privacy, and homomorphic encryption may be used to ensure privacy compliance while maintaining data utility. This improves privacy-preserving computation technology in network-based machine learning.

In some embodiments, the system may be extended to incorporate a predictive caching subsystem for advertisement assets. The technical problem addressed is preloading large media files over fluctuating network conditions. The system may predict future ad impressions based on network usage trends and cache only relevant media assets near the user's router or access point. Techniques such as predictive graph neural networks (GNNs) or time-series forecasting may be used. This improves edge caching and content delivery technology by reducing latency and data transfer overhead.

In some embodiments, the system may include a cross-network identity correlation engine that builds unified lifestyle profiles from multiple routers or access points associated with the same household or enterprise. The technical problem is fragmented user context across different network nodes. The engine may employ privacy-safe graph embedding and entity resolution algorithms to correlate device clusters and merge behavioral signatures. This improves cross-network behavioral analytics technology.

In some embodiments, the system may implement an adaptive advertisement pacing controller that dynamically modulates ad delivery frequency based on current network load or congestion signals. The technical problem is balancing ad delivery timeliness with network stability. The controller may use software-defined networking (SDN) feedback or congestion-aware reinforcement models to adjust pacing in real time. This improves network control technology and ensures Quality of Experience (QoE) compliance.

In some embodiments, the system may include a generative AI module capable of automatically creating ad content variants optimized for different user clusters. The technical problem addressed is the manual and time-consuming process of generating diverse ad creatives. The module may use large language and diffusion models (such as GPT-type or Stable Diffusion models) to automatically synthesize text and imagery aligned with predicted lifestyle indicators. This improves generative content automation technology.

In some embodiments, the system may integrate a neuro-symbolic reasoning engine that combines neural inference with rule-based logic to ensure compliance with advertiser policies and regulatory guidelines. The technical problem is that purely neural models cannot enforce hard constraints such as “do not advertise alcohol to minors.” The neuro-symbolic layer may evaluate logical rules alongside learned predictions to filter ad delivery decisions. This improves AI interpretability and rule compliance technology.

In some embodiments, the system may incorporate a quantum-enhanced optimization module for large-scale ad allocation problems. The technical problem is the combinatorial complexity of matching millions of ads to millions of network users under budget and bandwidth constraints. Quantum annealing or hybrid quantum-classical solvers may be used to identify near-optimal ad delivery strategies in polynomial time. This improves quantum optimization technology as applied to distributed ad systems.

In some embodiments, the system may implement a contextual sentiment inference subsystem that continuously monitors anonymized textual or audiovisual communication metadata within privacy limits to infer community sentiment shifts. The technical problem addressed is maintaining real-time alignment of ad tone with public mood dynamics. The subsystem may apply transformer-based sentiment classifiers on aggregated, anonymized text or voice signals. This improves sentiment-adaptive content delivery technology.

In some embodiments, the system may further include a zero-trust secure data sharing mechanism between advertisers and service providers. The technical problem is secure exchange of engagement analytics without compromising proprietary data. The system may use blockchain smart contracts or confidential computing enclaves to allow verifiable yet privacy-preserving access. This improves secure data exchange technology.

In some embodiments, the system may employ a self-healing AI orchestration framework to detect performance drift or bias in deployed machine learning models and autonomously recalibrate parameters or retrain submodules. This improves AI lifecycle management technology, ensuring model stability and fairness over time.

Although the invention has been explained in relation to its preferred embodiment, it is to be understood that many other possible modifications and variations can be made without departing from the spirit and scope of the invention as hereinafter claimed.

1. A method of facilitating user-subsidized purchase of a product or a service based on active advertisement viewing, the method comprising:
receiving, using a communication device, an advertisement selection data from a client device;
receiving, using the communication device, an advertisement interaction data representing a user interaction with a selected advertisement from the client device;
determining, using a processing device, a point value associated with the advertisement interaction data;
accumulating, using a processing device, a total point data based on the point value;
storing, using a storage device, the total point data in association with a user account data; and
transmitting, using the communication device, a credit data representing a redeemable value derived from the total point data to the client device.

2. The method of claim 1, further comprising:
analyzing, using the processing device, the advertisement selection data to extract a content descriptor; and
categorizing, using the processing device, the advertisement selection data into a category data based on the content descriptor.

3. The method of claim 1, further comprising:
computing, using the processing device, an incremental point data from the advertisement interaction data; and
updating, using the processing device, the total point data by adding the incremental point data.

4. The method of claim 3, further comprising:
detecting, using the processing device, a predefined engagement action in the advertisement interaction data;
determining, using the processing device, an additional point value based on the predefined engagement action; and
adding, using the processing device, the additional point value to the total point data.

5. The method of claim 1, further comprising:
comparing, using the processing device, the total point data with a threshold value;
converting, using the processing device, the total point data into the credit data based on the comparing; and
storing, using the storage device, the credit data in association with the user account data.

6. The method of claim 1, further comprising:
determining, using the processing device, an expiration data associated with the total point data;
comparing, using the processing device, a current time data with the expiration data; and
deleting, using the storage device, the total point data when the current time data exceeds the expiration data.

7. The method of claim 5, further comprising:
identifying, using the processing device, a payment record associated with the user account data; and
applying, using the processing device, the credit data to the payment record to offset a bill amount.

8. The method of claim 1, wherein the client device comprises one of a mobile device, a web device, or a television device capable of transmitting the advertisement selection data to the communication device, wherein the communication device is configured for receiving the advertisement selection data through a network connection.

9. The method of claim 1, further comprising:
generating, using the processing device, an advertisement performance data based on the advertisement interaction data and the total point data;
storing, using the storage device, the advertisement performance data for analytical evaluation; and
transmitting, using the communication device, a summarized analytic data to an advertiser system.

10. The method of claim 1, further comprising:
generating, using the processing device, a settlement data representing a monetary value equivalent to the credit data;
verifying, using the processing device, a billing account data of an advertiser system; and
transmitting, using the communication device, the settlement data to the advertiser system for payment processing.

11. A system for facilitating user-subsidized purchase of a product or a service based on active advertisement viewing, the system comprising:
a communication device configured for:
receiving an advertisement selection data from a client device;
receiving an advertisement interaction data representing a user interaction with a selected advertisement from the client device; and
transmitting a credit data representing a redeemable value derived from a total point data to the client device;
a processing device configured for:
determining a point value associated with the advertisement interaction data; and
accumulating the total point data based on the point value;
a storage device configured for storing the total point data in association with a user account data.

12. The system of claim 11, wherein the processing device is further configured for:
analyzing the advertisement selection data to extract a content descriptor; and
categorizing the advertisement selection data into a category data based on the content descriptor.

13. The system of claim 11, wherein the processing device is further configured for:
computing an incremental point data from the advertisement interaction data; and
updating the total point data by adding the incremental point data.

14. The system of claim 13, wherein the processing device is further configured for:
detecting a predefined engagement action in the advertisement interaction data;
determining an additional point value based on the predefined engagement action; and
adding the additional point value to the total point data.

15. The system of claim 11, wherein the processing device is further configured for:
comparing the total point data with a threshold value; and
converting the total point data into the credit data based on the comparing, wherein the storage device is further configured for storing the credit data in association with the user account data.

16. The system of claim 11, wherein the processing device is further configured for:
determining an expiration data associated with the total point data; and
comparing a current time data with the expiration data, wherein the storage device is further configured for deleting the total point data when the current time data exceeds the expiration data.

17. The system of claim 15, wherein the processing device is further configured for:
identifying a payment record associated with the user account data; and
applying the credit data to the payment record to offset a bill amount.

18. The system of claim 11, wherein the client device comprises one of a mobile device, a web device, or a television device capable of transmitting the advertisement selection data to the communication device, wherein the communication device is configured for receiving the advertisement selection data through a network connection.

19. The system of claim 11, wherein the processing device is further configured for generating an advertisement performance data based on the advertisement interaction data and the total point data, wherein the communication device is further configured for transmitting a summarized analytic data to an advertiser system, wherein the storage device is further configured for storing the advertisement performance data for analytical evaluation.

20. The system of claim 11, wherein the processing device is further configured for:
generating, using the processing device, a settlement data representing a monetary value equivalent to the credit data;
verifying, using the processing device, a billing account data of an advertiser system, wherein the communication device is configured for transmitting the settlement data to the advertiser system for payment processing.
